(19) United States
(12) Patent Application Publication
(10) Pub. No.: US 2025/0292506 A1
(43) Pub. Date: Sep. 18, 2025

(54) INFORMATION PROCESSING METHOD, INFORMATION PROCESSING DEVICE, AND INFORMATION PROCESSING SYSTEM

(71) Applicant: SONY GROUP CORPORATION, TOKYO (JP)

(72) Inventors: TAKASHI KONNO, TOKYO (JP); SHINICHIRO ABE, TOKYO (JP); TAKUTO MOTOYAMA, TOKYO (JP); KENICHIRO OI, TOKYO (JP); EISUKE NOMURA, TOKYO (JP); KOHEI URUSHIDO, TOKYO (JP)

(21) Appl. No.: 18/863,156

(22) PCT Filed: May 8, 2023
(86) PCT No.: PCT/JP2023/017286

§ 371 Date: Nov. 5, 2024

(30) Foreign Application Priority Data
May 13, 2022 (JP) 2022-079687

(51) Int. Cl. G06T 17/20; G06T 7/11; G06T 7/12; G06T 7/13; G06T 7/70; G06T 17/05; G06V 20/52

(52) U.S. Cl. CPC G06T 17/20; G06T 7/11; G06T 7/12; G06T 7/13; G06T 7/70; G06T 17/05; G06V 20/52; G06T 2207/20164

(57) ABSTRACT

[Object] A map is created efficiently.

[Solution] An information processing method according to the present disclosure includes: creating, on the basis of environmental information that indicates an environment of a target region, a first map that indicates a movable region and an immovable region in the target region; on the basis of the first map, moving a mobile object including a sensor in the target region, and observing the environment of the target region, thereby creating a second map that indicates the movable region and the immovable region in the target region; and combining the first map and the second map, thereby creating a third map.

### TECHNICAL FIELD

The present disclosure relates to an information processing method, an information processing device, and an information processing system.

### BACKGROUND ART

In recent years, in order to efficiently move autonomously mobile objects such as vehicles and robots, maps representing information related to the target region are created in advance. Moving mobile objects by using previously created maps allows efficient implementation of various tasks.

For example, PTL 1 discloses a method for causing a robot to move autonomously through a store to collect information on products placed on shelves in the store and generate a shelf allocation list on the basis of the locations of the products.

As a method for using two-dimensional maps, PTL 2 discloses a method for obtaining two-dimensional map data in accordance with the detected current position for automobile navigation, and creating a three-dimensional map, thereby providing guidance.

### CITATION LIST

### Patent Literature

### [PTL 1]

Japanese Translation of PCT Application No. 2019-523924

### [PTL 2]

JP 2006-119090A

### SUMMARY

### Technical Problem

Creating maps for such purposes has been time-consuming and labor-intensive. For example, it takes a long time and laborious efforts for an operator to create such a map through operation of a robot. Even in a case of having a robot create a map automatically, since the robot needs to perform exploration, it is time-consuming and a problem of omissions may arise. Therefore, it has been difficult to create maps efficiently.

The present disclosure has been made in view of the above-mentioned problems, and an object of the present disclosure is to create a map efficiently.

### Solution to Problem

An information processing method according to the present disclosure includes creating, on the basis environmental information that indicates an environment of a target region, a first map that indicates a movable region and an immovable region in the target region; on the basis of the first map, moving a mobile object including a sensor in the target region and observing the environment of the target region, thereby creating a second map that indicates a movable region and an immovable region in the target region; and combining the first map and the second map, thereby creating a third map.

An information processing device according to the present disclosure includes: a first map creation unit configured to create a first map that indicates a movable region and an immovable region in a target region on the basis of environmental information about an environment of the target region; a second map creation unit configured to, on the basis of the first map, move a mobile object including a sensor in the target region and observe the environment of the target region, thereby creating a second map that indicates a movable region and an immovable region in the target region; and a third map creation unit configured to combine the first map and the second map, thereby creating a third map.

An information processing system according to the present disclosure includes: a mobile object having a sensor configured to observe an environment of a target region and an information processing device capable of communicating with the mobile object, the information processing device includes a first map creation unit configured to create, on the basis of environmental information indicating the environment of the target region, a first map that indicates a movable region and an immovable region in the target region, the mobile object or the information processing device includes a second map creation unit configured to, on the basis of the first map, move the mobile object in the target region and observe the environment of the target region, thereby creating a second map that indicates a movable region and an immovable region in the target region, and the information processing device includes a third map creation unit configured to combine the first map and the second map, thereby creating a third map.

### BRIEF DESCRIPTION OF DRAWING

FIG. 1 illustrates a configuration example of a map creation system according to an embodiment of the present disclosure.

FIG. 2A illustrates the overall processing performed by the map creation system.

FIG. 2B illustrates the overall processing performed by the map creation system.

FIG. 3 is a block diagram of a configuration of the map creation system.

FIG. 4 is a flowchart for illustrating map creation processing.

FIG. 5 is a flowchart for illustrating a first example of occupancy map creation processing.

FIG. 6 illustrates an example of environmental information in the form of an image.

FIG. 7 is a flowchart for illustrating a second example of the occupancy map creation processing.

FIG. 8 is a table illustrating meta information extracted from a floor map.

FIG. 9 is a flowchart for illustrating a third example of the occupancy map creation processing.

FIG. 10 is a table illustrating meta information generated from a floor map.

FIG. 11 is a flowchart for illustrating a fourth example of the occupancy map creation processing.

FIG. 12 is a flowchart for illustrating a fifth example of the occupancy map creation processing.

FIG. 13 is a flowchart for illustrating a sixth example of the occupancy map creation processing.

FIG. 14 is a table illustrating meta information generated from a satellite photo.

FIG. 15 is a flowchart for illustrating waypoint setting processing.

FIG. 16A illustrates the waypoint setting processing.

FIG. 16B illustrates the waypoint setting processing.

FIG. 17 is a flowchart for illustrating final map creation processing.

FIG. 18 illustrates the final map creation processing.

FIG. 19 is a diagram of an exemplary hardware configuration of the information processing device according to the present disclosure.

### DESCRIPTION OF EMBODIMENTS

Embodiments of the present disclosure will be described in detail with reference to the accompanying drawings. In the specification and the drawings, elements having substantially the same functional configurations are denoted by the same reference numerals, and their descriptions will not be repeated.

Now, a mode for carrying out the present technology will be described. The description will be made in the following order.
1. Outline of map creation
2. Occupancy map creation
3. Arrangement of waypoints and generation of action plans
4. Creation of preliminary map and intermediate map
5. Final map creation
6. Conclusion
7. Application examples
8. Supplements

### <1. Outline of Map Creation>

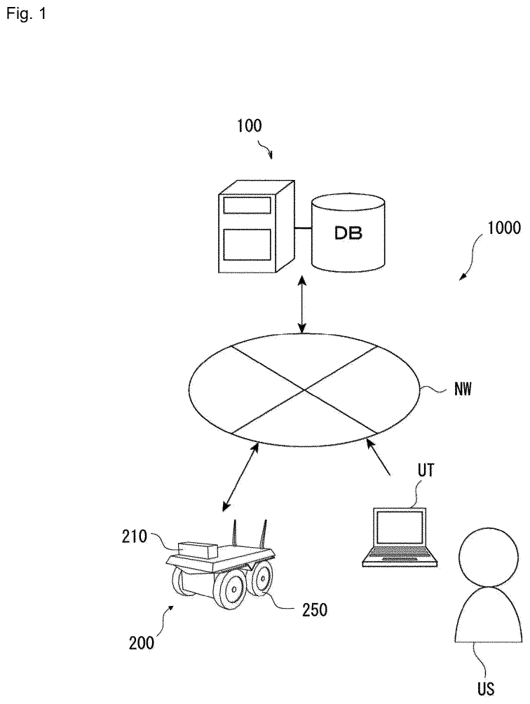

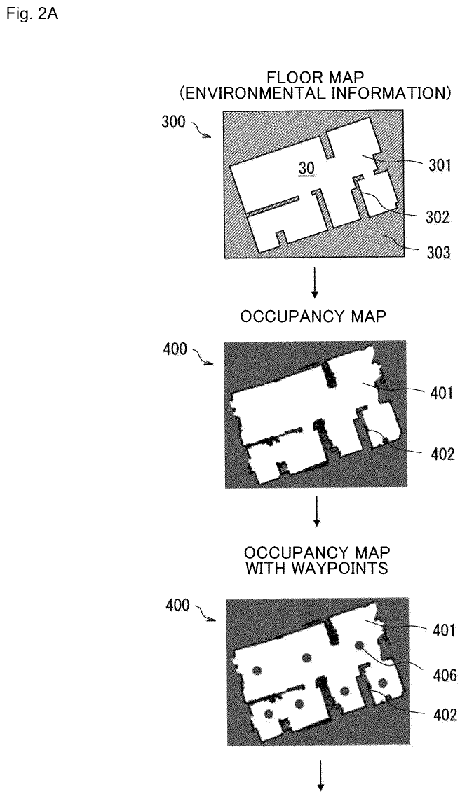

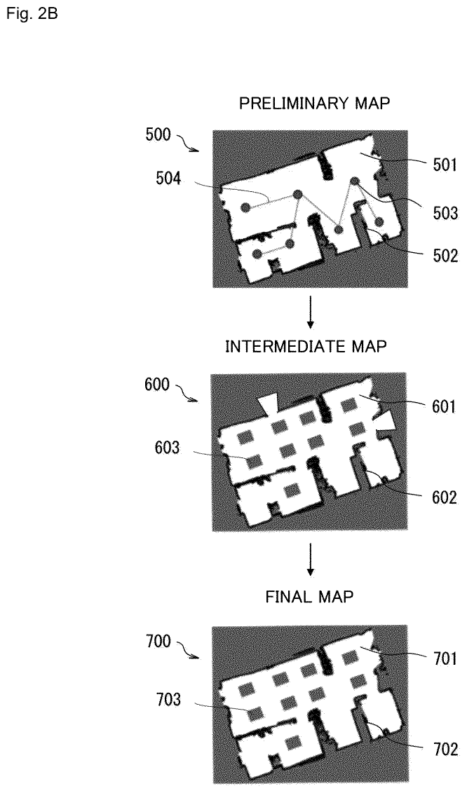

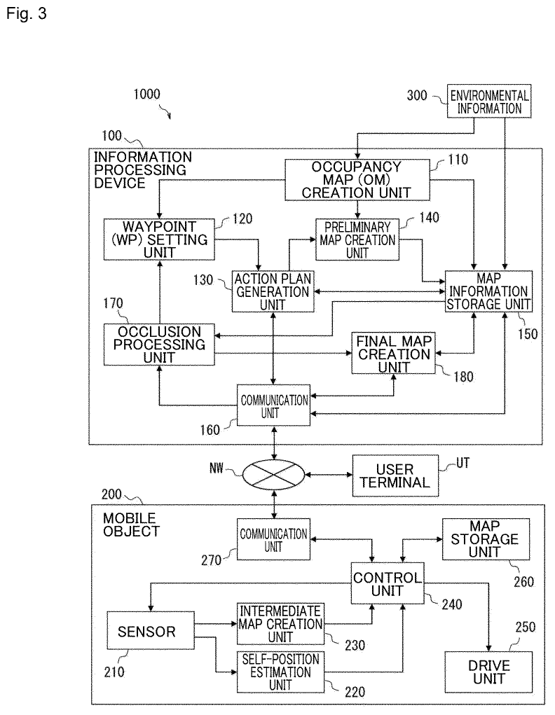

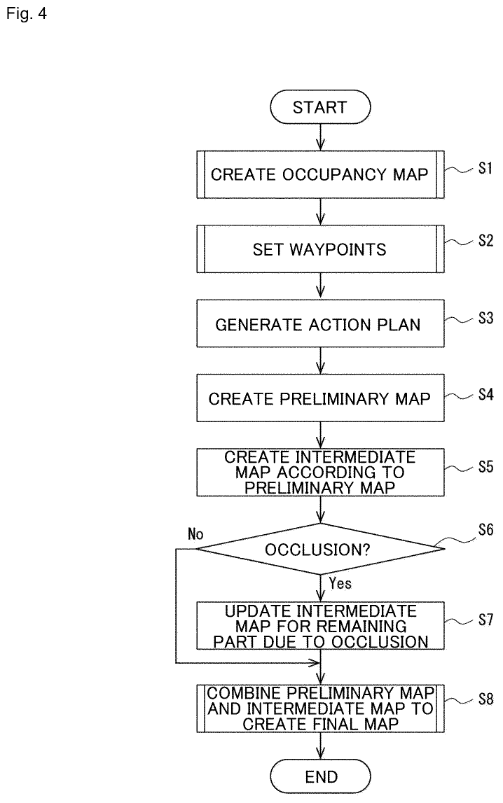

The outline of map creation according to an embodiment of the present technology will be described. FIG. 1 illustrates a configuration example of a map creation system according to an embodiment of the present disclosure. The map creation system 1000 is an example of an information processing system according to an embodiment of the present disclosure. FIGS. 2A and 2B illustrate the overall processing performed by the map creation system. FIG. 3 is a block diagram of an exemplary configuration of the map creation system. FIG. 4 is a flowchart for illustrating the map creation processing.

The map creation system 1000 shown in FIG. 1 includes an information processing device 100 that includes a database and a mobile object 200, which executes the processing that will be described below in response to instructions from a user terminal UT. The information processing device 100, the mobile object 200, and the user terminal UT are connected in a manner that allows communication with each other over a network NW. The user terminal UT stores environmental information that represents the environment of a target region for which a map is to be created. As an example, if a floor of a building is the target region, an image of a floor map of the floor is stored in the user terminal UT as the environmental information, and processing is executed using the image.

The information processing device 100 has a database and can store various kinds of information related to the map creation system 1000. The information processing device 100 controls the mobile object 200 to be actually moved in a target region 30 and perform observation operation (sensing operation) to create a map. The information processing device 100 also reads various kinds of information from the database and outputs the information for example to the mobile object 200 or the user terminal UT.

The mobile object 200 is for example a vehicle, such as an AGV (Automated Guided Vehicle) and has a sensor 210 such as a camera and a range sensor and a drive system including a drive unit 250. The mobile object can also be a drone that flies autonomously or any other device that moves autonomously.

The user terminal UT includes various devices that can be used by the user US. For example, a personal computer (PC) and a smartphone are used as the user terminals UT. The user US transmits instruction data via the user terminal UT to have the map creation system 1000 create a map. The user terminal UT also displays for example the map received from the information processing device 100 on a screen and makes it available to the user US for viewing.

The network NW is built using, for example, the Internet or a wide-area telecommunications network. Any other WAN (Wide Area Network) or LAN (Local Area Network) may be used for the network NW, and the protocol for building the network NW is not limited. For example, the information processing device 100 may be connected to the mobile object 200 or the user terminal UT by short-range wireless communication such as Bluetooth® without constructing a cloud network.

According to the embodiment, the network NW and the information processing device 100 may be configured to provide a so-called cloud service. In this case, the user terminal UT could be regarded as being connected to the cloud network.

In the map creation system 1000, the information processing device 100 receives environmental information 300 and map creation instructions from the user terminal UT operated by the user US. As shown in FIG. 2A, the information processing device 100 creates an occupancy map 400 on the basis of the environmental information 300 and the map creation instructions. The environmental information 300 represents the environment of the target region 30. The occupancy map 400 corresponds to a first map representing a movable region 401 (e.g., floor) and an immovable region 402 (e.g., wall) in the target region 30. More specifically, the occupancy map 400 represents, for each unit region obtained by dividing the target region 30 divided into multiple areas, the probability of whether the area is an immovable region. For example, in the occupancy map 400, the movable region 401 corresponds to an area that has a probability of being an immovable region equal to or less than a first threshold, and the immovable region 402 corresponds to an area that has a probability of being an immovable region equal to or greater than a second threshold.

Next, the information processing device 100 sets a waypoint 406 (observation point), which indicates the point at which the mobile object 200 including the sensor 210 is to be moved, in the movable region in the occupancy map 400. The occupancy map having the waypoint 406 therein is referred to as the occupancy map 400A. The information processing device 100 then creates a preliminary map 500 by assigning an action plan to the occupancy map 400A, which includes the moving path (travel route) of the mobile object 200 and the content of the observation operation. In FIG. 2B, the preliminary map 500 includes a movable region 501, an immovable region 502, a waypoint 503, and a moving path 504. The mobile object 200 then moves through the target region 30 on the basis of the preliminary map 500 to observe the environment of the target region 30, so that an intermediate map 600 is created. The intermediate map 600 corresponds to a second map representing the movable and immovable regions in the target region 30, which is created by observing the target environment with the sensor of the mobile object 200. In FIG. 2B, the intermediate map 600 includes a movable region 601 (floor in this example), an immovable region 602 (wall in this example), and an immovable region 603 (table in this example).

Finally, the information processing device 100 synthesizes the occupancy map 400 and the intermediate map 600 to create a final map 700. The final map 700 corresponds to a third map, which is a combination of the first map with the second map. The final map 700 is the most up-to-date map representing the environment of the target region 30, which includes the real-time placement of obstacles during the creation of the intermediate map 600. The final map 700 can be used to allow the mobile object 200 and other elements to perform arbitrary tasks efficiently.

As another example of a mobile object 200, an operator with a smartphone may act as the mobile object 200. In this case, the operator moves through each waypoint while viewing the preliminary map 500 received by the smartphone from the information processing device 100. At each waypoint, the operator observes the environment in the target region 30 using a sensor 210 such as a LiDAR sensor mounted on the smartphone. In this case, the intermediate map 600 can be created as is the case with the mobile object 200 that will be described.

Next, a configuration of the information processing device 100 according to the embodiment will be described with reference to FIG. 3. The information processing device 100 has an occupancy map creation unit 110, a waypoint setting unit 120, an action plan generation unit 130, a preliminary map creation unit 140, a map information storage unit 150, a communication unit 160, an occlusion processing unit 170, and a final map creation unit 180.

The occupancy map creation unit (“OM creation unit”) 110 creates the occupancy map 400 on the basis of the environmental information 300 transmitted from the user terminal UT and received via the communication unit 160. The OM creation unit 110 outputs the created occupancy map 400 to a waypoint setting unit (hereinafter referred to as the “WP setting unit”) 120, the preliminary map creation unit 140, and the map information storage unit 150.

Here, the environmental information 300 includes images of the environment of the target region 30. The environmental information 300 includes data that includes at least one of graphical or linguistic elements about the environment of the target region 30 for which the map is to be created. The environmental information 300 is, for example, a floor map illustrating the target region 30, a drawing, a plan created by a computer-aided design (CAD) tool or map information or a satellite photograph obtained from a consumer map application. The environmental information 300 may also be an image or video of the environment in the target region 30 or a 3D model created from these images or videos. The environmental information 300 may also be a two-dimensional hand-drawn sketch of the environment in the target region 30. The environmental information 300 may include not only data that graphically represents the environment of the target region 30 but also meta information indicating the attributes of objects included in the target region 30.

The environmental information 300 may be an image composed of pixels (raster data). The environmental information 300 as the raster data is created by digitally capturing for example a photograph, an analog drawing or an illustration generated analogically. The environmental information 300 may also be vector data, such as design plan, where the target region 30 is represented by coordinate value data of the start and end points of line segments, which allows for graphical display The environmental information 300 may also be text data such as meta information that indicates the content of a diagram.

The WP setting unit 120 sets multiple waypoints (observation points) 406 in the occupancy map 400 on the basis of the observation range of the sensor 210 mounted on the mobile object 200 (see FIG. 2A). The WP setting unit 120 outputs the set waypoints 406 to the action plan generation unit 130. The WP setting unit 120 may also set waypoints 406 when there remains an area that has not been observed by the mobile object 200 after a series of operations of the mobile object 200 to create the intermediate map 600 (details of which will be described).

The action plan generation unit 130 generates an action plan (first action plan) to move the mobile object 200 on the basis of the plurality of waypoints 406 and to have the mobile object 200 perform observation with the sensor 210 at the plurality of waypoints 406. The action plan includes a moving path that connects the multiple waypoints 406 in a sequence that enables the fastest possible movement, and the details of the observation operation of the environment to be performed at the waypoints (e.g., observing 360 degrees around the waypoints). The action plan generation unit 130 outputs the generated action plan to the preliminary map creation unit 140.

When there remains an unobserved region after the mobile object 200 has created the intermediate map 600, the action plan generation unit 130 creates an action plan (second action plan) to have the mobile object 200 observe the environment of the unobserved region, and outputs the plan to the communication unit 160 for transmission to the mobile object 200.

The preliminary map creation unit 140 creates a preliminary map 500 in which the moving path and observation operation of the mobile object 200 are set in the occupancy map 400A, and outputs the map to the map information storage unit 150.

The map information storage unit 150 is a database that stores various maps and related information. The map information storage unit 150 stores the environmental information 300, the occupancy map 400, the preliminary map 500, the intermediate map 600, and the final map 700, and performs input/output processing with other functional units.

The communication unit 160 communicates with the mobile object 200 and the user terminal UT and other devices over the network NW, transmits data supplied by the various parts of the information processing device 100, and supplies the received data to the various parts of the information processing device 100. The communication protocols supported by the communication unit 160 are not limited. For example, the communication unit 160 communicates wirelessly with the user terminal UT and the mobile object 200 by the Internet, cellular communication, any WAN, wireless LAN, Bluetooth®, NFC (Near Field Communication), or WUSB (Wireless USB). The communication unit 160 may support multiple types of communication protocols.

The occlusion processing unit 170 determines whether there is an occlusion or unobserved region (hereinafter “occlusion, etc.”) in the intermediate map 600, and if there is an occlusion, etc., the unit performs processing to update the intermediate map 600. Here, the occlusion refers to a state in which an object in front of the mobile object hides another object behind itself from the mobile object as well as the existence of an area that is hidden as a result. The occlusion processing unit 170 compares the occupancy map 400 or the preliminary map 500 created by the information processing device 100 with the intermediate map 600 created by the mobile object 200. In this way, the occlusion processing unit 170 identifies the part for which the intermediate map 600 has not been created. The occlusion processing unit 170 then causes the WP setting unit 120 to set waypoints to update the intermediate map 600 for the unobserved region and causes the action plan generation unit 130 to generate an action plan in order to have the environment of the area unobserved due to the occlusion, etc., observed.

When the intermediate map 600 has been created without occlusion, the final map creation unit 180 creates the final map 700 by combining the preliminary map 500 and the intermediate map 600. The final map 700 is transmitted to the user terminal UT via the communication unit 160 and the network NW, and the final map 700 is stored in the map information storage unit 150.

Hereinafter, the configuration of the mobile object 200 according to the embodiment will be described with reference to FIG. 3. The mobile object 200 has the sensor 210, the self-position estimation unit 220, an intermediate map creation unit 230, a control unit 240, a drive unit 250, a map storage unit 260, and a communication unit 270.

The sensor 210 includes at least one of an external sensor and an inner sensor. The external sensor of the sensor 210 obtains information about the environment surrounding the mobile object 200 (e.g., information about surrounding objects) under the control of control unit 240. The external sensor may include a monocular camera, a stereo camera, a depth sensor (ranging sensor), and a LiDAR (Light Detection and Ranging, Laser Imaging Detection and Ranging) that can observe the environment of the target region 30 or any combination of the above. The environment of the target region 30 can be observed using these sensors 210 to output at least one of ranging data and images and to identify obstacles included in the target region 30. A plurality of these sensors may be provided as the sensor 210. The external sensor is provided so that the sensor can observe ahead of the mobile object 200 but may be configured to have the observation direction varied.

For example, ranging sensors (such as LiDAR, TOF (Time Of Flight), monocular camera, and stereo camera) are used as external sensors. The camera includes a solid-state imaging device such as a CMOS (Complementary Metal Oxide Semiconductor) image sensor or a CCD (Charge Coupled Device) image sensor to capture images ahead of the mobile object 200 (including the arrangement of objects). By configuring the camera as a stereo camera, information on the depth direction in front of the mobile object 200 obtained by the camera may be used as distance information. A so-called 360-degree camera that captures images of the mobile object 200 in all directions may also be used as the camera. By using the camera, the environment around the mobile object 200 can also be observed without stopping at waypoints, since there is no need to change the posture to observe the environment. For this reason, the mobile object 200 may be configured with a plurality of various sensors facing outward with the mobile object 200 at the center.

The LiDAR, a ranging sensor, measures the distance to an obstacle in front of the mobile object 200 by projecting a laser beam ahead of the vehicle and receiving the reflected light from the obstacle by the ToF (Time of Flight) method. The LiDAR may be installed on the top surface of the mobile object 200 and a laser beam may be projected while being rotated in the horizontal plane to observe the environment around the mobile object 200 without stopping at waypoints.

The external sensor generates observation data (ranging data) indicating at least one of the distance to surrounding objects and the arrangement of the surrounding objects, or images (e.g., moving images) of the surrounding environment and outputs them to the self-position estimation unit 220 and the intermediate map creation unit 230.

The inner sensor of the sensor 210 obtains information about the mobile object 200 itself (e.g., information indicating the position and posture of the mobile object 200 and changes thereof). The inner sensor is at least one of a position sensor, an angle sensor, an acceleration sensor, and a gyro sensor. The inner sensor outputs the generated observation data (also referred to as “inner observation data”) to the self-position estimation unit 220.

The self-position estimation unit 220 estimates the self-position on the basis of at least one of the inner observation data and the ranging data generated by the sensor 210, and outputs the self-position information indicating the estimated self-position to the control unit 240.

The intermediate map creation unit 230 repeatedly executes the processing of calculating the position of objects in the vicinity on the basis of the inner observation data and the ranging data generated by the sensor 210. As a result, the intermediate map creation unit 230 creates an intermediate map 600 indicating a region in which the mobile object 200 can move (free space) and a region in which the mobile object cannot move (obstacle) in the target region 30 and outputs the map to the control unit 240.

The control unit 240 performs various kinds of control related to the autonomous movement of the mobile object 200 on the basis of the preliminary map 500 created by the information processing device 100. Specifically, the control unit 240 generates a drive signal for movement according to the action plan in the preliminary map 500 for example by performing self-position estimation, analyzing the surrounding situation, and controlling the drive system on the basis of the preliminary map 500 and the self-position information output from the self-position estimation unit 220. The control unit 240 supplies the generated drive signal to the drive unit 250. The control unit 240 also controls the observation operation by the sensor 210. In this way, the mobile object 200 travels autonomously and performs ranging and photographing automatically. The configuration and method for example for realizing the autonomous operation and automated photography performed by the control unit 240 are not limited, and any technology may be used.

By performing the control described above, the control unit 240 controls various parts of the mobile object 200 to create an intermediate map 600 on the basis of the preliminary map 500 received from the information processing device 100. The control unit 240 then transmits the intermediate map 600 to the information processing device 100 and has the map stored in the map storage unit 260. The control unit 240 also updates the intermediate map 600 by executing an action plan for an unobserved region in the intermediate map 600. The control unit 240 may also transmit the ranging data and inner observation data obtained by the sensor 210 to the information processing device 100 and cause the information processing device 100 to create the intermediate map 600.

The drive unit 250 includes wheels and a drive source (e.g., a motor and a battery), drives the wheels with the drive source in response to a drive signal from the control unit 240 and moves the mobile object 200.

The map storage unit 260 stores the preliminary map 500 received from the information processing device 100 under the control of the control unit 240 and also stores the intermediate map 600 created by the intermediate map creation unit 230.

The communication unit 270 performs wireless communication with the communication unit 160 of the information processing device 100. The communication unit 270 uses a communication method supported by the information processing device 100 for wireless communication. The communication unit 270 performs wireless communication with the information processing device 100, receives the preliminary map 500 and transmits the intermediate map 600 under the control of the control unit 240.

Next, with reference to FIG. 4, an outline of the map creation processing performed by the map creation system 1000 will be described. When the information processing device 100 receives the environmental information 300 and a map creation instruction from the user terminal UT, the OM creation unit 110 creates the occupancy map 400 (S1).

Next, the WP setting unit 120 sets waypoints in the occupancy map 400 and creates the occupancy map 400A with waypoints set (S2).

Next, the action plan generation unit 130 of the information processing device 100 creates an action plan (a moving path and the details of the observation operation) on the basis of the occupancy map 400A (S3). Next, the preliminary map creation unit 140 creates a preliminary map 500 by adding the details of the action plan to the occupancy map 400A (S4). Next, the intermediate map creation unit 230 of the mobile object 200 creates the intermediate map 600 by moving the mobile object 200 on the basis of the preliminary map 500 and having the mobile object observe the target environment (S5). Next, the occlusion processing unit 170 of the information processing device 100 determines whether there is occlusion, etc., on the basis of the intermediate map 600 (S6). If there is occlusion, etc., in other words, if there is a part that remains unobserved by the mobile object 200 (unobserved part), the unobserved part is observed by the mobile object 200, and the intermediate map creation unit 230 of the mobile object 200 updates the intermediate map 600 (S7). The final map creation unit 180 then combines the preliminary map 500 and the intermediate map 600 to create the final map 700 (S8).

### 2. <Occupancy Map Creation>

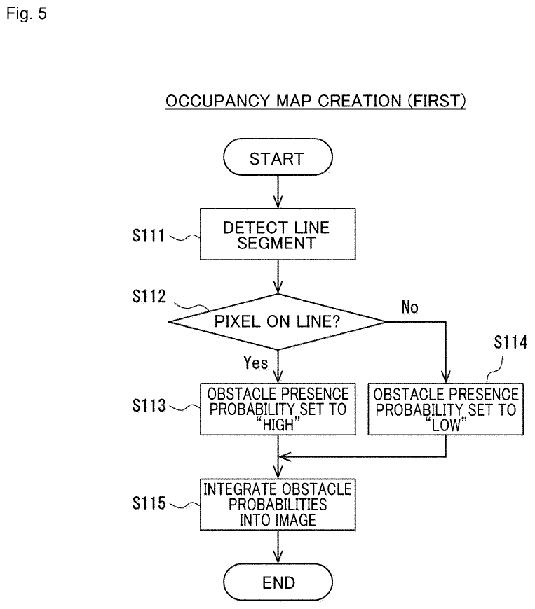

Next, the specific processing details of the above-described map creation processing will be described. With reference to FIGS. 5 to 14, six methods for creating the occupancy map 400 will be described. The information processing device 100 may be configured to perform any or all of these processing steps to create the occupancy map 400.

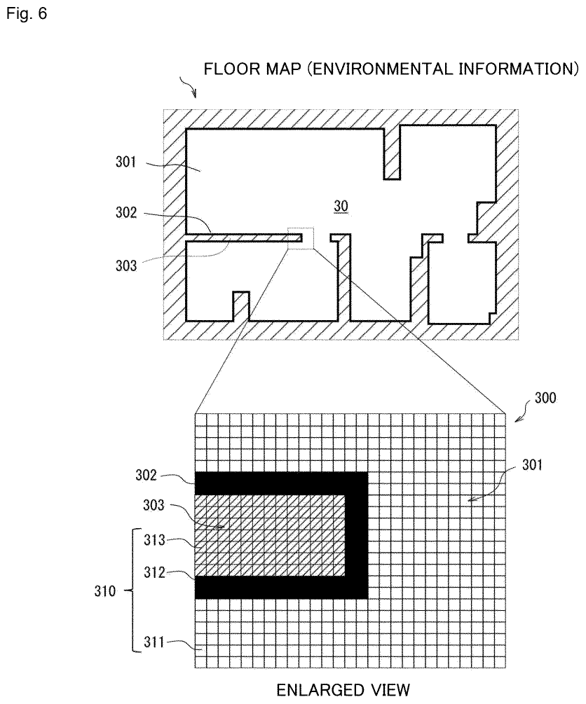

FIG. 5 is a flowchart for illustrating a first example of occupancy map creation processing. The processing is performed when image data such as a floor map is sent from the user terminal UT to the information processing device 100 as the environmental information 300. The environmental information 300 in this processing includes an image of a floor map, which illustrates the environment of the target region 30. FIG. 6 illustrates an example of environmental information in the form of an image. The environmental information 300 in FIG. 6 is an image having a large number of pixels 310 (unit regions) arranged in a matrix of rows and columns. In other words, the pixels 310 are pixels in the image of the environmental information 300.

As shown in FIG. 6, the environmental information 300 as an example is a floor map. The environmental information 300 as a floor map, for example, represents a part 301 representing a floor, which is a region where the mobile object 200 can move, a line segment 302 representing a wall, which is a region where the mobile object 200 cannot move, and an obstacle 303 which is an immovable region delineated with the line segment 302 as a boundary. The information used to identify the outside of the line segment 302 representing the wall as an obstacle (outside the floor) may be input from the user terminal UT as the environmental information 300. Alternatively, the obstacle may be identified by an existing method such as semantic segmentation in the information processing device 100.

In the creation processing, when the environmental information 300, which is the floor map of the target region 30, is input, the OM creation unit 110 of the information processing device 100 first detects the line segment 302 from the image (S111), as shown in FIG. 5. In the detection processing, the OM creation unit 110 performs image expansion processing (dilation processing) on the environmental information 300, which is the image of the floor map, to remove noise, and then detects the line segment 302 using existing means, such as LSD (Line Segment Detector). As the line segment 302 is detected by binarization of the image, the pixels 310 in the floor map image are divided into pixels 312 that are on the line segment 302 and pixels 311 and 313 that are not included in the line segment.

Next, the OM creation unit 110 determines whether all of the pixels 310 of the image of the environmental information 300 are included in the line (S112). In this case, as shown in FIG. 6 the OM creation unit 110 determines that the pixels are either the pixels 311 and 313 detected as not included in the line segment 302 or the pixels 312 detected as included in the line segment 302 (pixels 312 included in the line).

The OM creation unit 110 then sets an obstacle presence probability to “high” with a value of “0.8” (a second threshold) if a pixel 310 is included in the line (S113). The pixel 310 corresponds to the pixel 312 painted in black in the enlarged view in FIG. 6. Here, as for the obstacle presence probability, the probability of being an obstacle can be set to a value from not less than 0 to not more than 1. As for the obstacle presence probability, the probability of being an obstacle is set to a value less than “1” in step S113 because there is a possibility that the pixel 310 may not be an obstacle even if it is included in the line.

In contrast, if the pixel 310 is not included in the line, the OM creation unit 110 sets the obstacle presence probability to “low” with a value of “0.2” (a first threshold) (S114). This corresponds to the unhatched pixels 311 and the hatched pixels 313 in the enlarged view in FIG. 6. Thus, the probability is set for each pixel 310 on the basis of whether a pixel corresponding to the pixel 312 is included in the line segment 302 detected by the above-described line segment detection.

Next, the OM creation unit 110 creates an occupancy map 400 with an obstacle presence probability set for each pixel. For each pixel 310 shown in the enlarged view in FIG. 6, the presence probability is set to “0.2” or “0.8” as described above. However, if the presence probability is set to “0.2” because the pixel 310 is not included in the line segment, and the pixel 310 is surrounded by the line segment 302, the pixel may be in a space into which the mobile object 200 cannot enter.

Therefore, assuming that the pixel 313 surrounded by the pixels 312 of the line segment 302 are likely to be a space that the mobile object 200 cannot enter, i.e., an obstacle, the OM creation unit 110 re-sets the obstacle presence probability to “0.8” for the pixel 313. In the case shown in FIG. 6, the part outside the continuous line segment 302 (equivalent to a wall) in the floor map is determined to be an obstacle, and objects such as table, chair, shelf, and partition placed on the floor are also considered to be obstacles. In this case, when processing an image of the environmental information 300 that includes an object acting as an obstacle, since the line segment 302 along the outline of the object is included, the pixels 313 within the region surrounded by the line segment 302 are also determined to be an obstacle. Thus, the obstacle presence probability is set to “0.8” for each pixel 313.

Through the above processing, the OM creation unit 110 sets a probability for each of pixels 310 on the basis of the possible presence or absence of an obstacle, and creates the occupancy map 400 that integrates these obstacle presence probabilities in the target region 30 into the image (S115). The OM creation unit 110 then outputs the created occupancy map 400 to the WP setting unit 120, the preliminary map creation unit 140, and the map information storage unit 150, and the processing ends. The values such as “0.2” and “0.8” are only examples representing low and high probabilities, and other values such as “0.3” and “0.9” may be used (likewise hereinafter).

As described above, in the first example of the processing for generating the occupancy map 400, the OM creation unit 110 sets the probability of whether the mobile object 200 can move within the area for each pixel 310, which is obtained by dividing the target region 30 into multiple parts on the basis of the environmental information 300 The OM creation unit 110 generates the occupancy map 400 that probabilistically indicates whether each pixel 310 corresponds to a movable or immovable region.

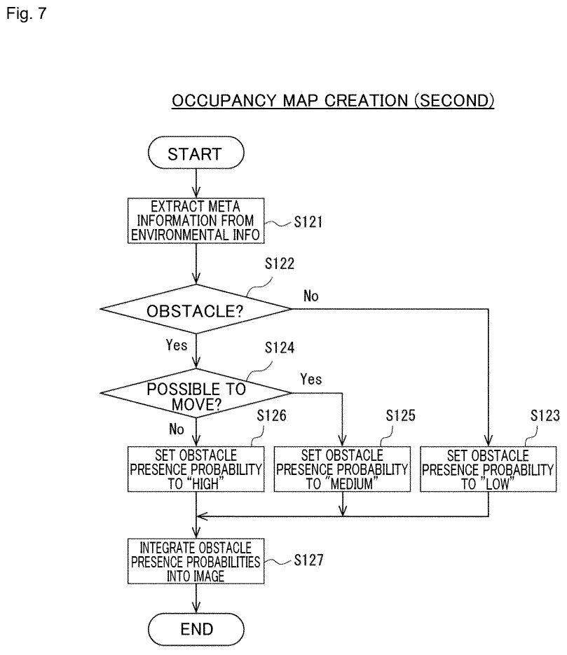

FIG. 7 is a flowchart for illustrating a second example of occupancy map creation processing. The processing is performed when data indicating a floor map (vector data or raster data) with meta information for each object existing on the floor is sent as the environmental information 300 from the user terminal UT to the information processing device 100. The environmental information 300 includes the position and outline of the objects present in the target region 30, and the names of the objects, for example, as meta information 320 about the objects. In the following description of the occupancy map creation processing, the same processing as described above may be simplified or omitted.

In the creation processing, upon receiving the environmental information 300 in the form of the floor map including the meta information 320, the OM creation unit 110 extracts the meta information 320 from the environmental information 300 (S121), as shown in FIG. 7. For example, the OM creation unit 110 extracts an object name for each of the objects present in the floor map and sets an obstacle possibility and movability on the basis of the object name. In this way, data is generated as meta information included in the environmental information 300, in which the types of objects on the floor and the obstacle possibility and movability are set for each type of object.

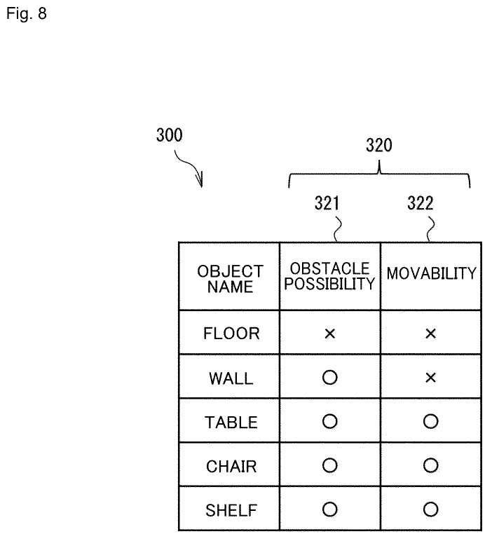

FIG. 8 is a table illustrating the meta information extracted from the floor map. As shown, the meta information 320 is output for each object such as “floor,” “wall,” “table,” “chair,” and “shelf,” with an obstacle possibility 321 and a movability 322 set for each object. More specifically, the meta information 320 includes the obstacle possibility 321, which indicates the likelihood that the region where the object is located is an immovable region for the mobile object 200, and the movability 322, which indicates the likelihood that the object's position may change.

Next, the OM creation unit 110 determines whether the object is an obstacle for each object in the target region 30 (S122). In this case, the OM creation unit 110 sets the obstacle presence probability to “low” with a value of “0.2” for an object that has no obstacle possibility, such as the “floor” shown in FIG. 8 (S123).

Meanwhile, the OM creation unit 110 determines whether an object that could possibly be an obstacle such as the “wall” or “desk” shown in FIG. 8 is movable (S124). In this case, for the object like the “desk” shown in FIG. 8, which is possibly movable, the OM creation unit 110 sets the obstacle presence probability to “medium” with a value of ‘0.5’ (S125). The OM creation unit 110 also sets the obstacle presence probability to “0.5” for the coordinates enclosed by the line segment that indicate an object in the target region 30, considering that the space is likely an obstacle where the mobile object 200 cannot enter.

Meanwhile, for an object that has no movability, such as the “wall” shown in FIG. 8, the OM creation unit 110 sets the obstacle presence probability to “high” with a value of “0.8” (S126). The OM creation unit 110 may also set the obstacle presence probability to “0.8” for a region outside the line segment that constitutes a wall, considering that the mobile object 200 cannot move there as well.

The OM creation unit 110 creates the occupancy map 400 after setting the obstacle presence probability for all objects in the target region 30 as described above.

Through the above processing, the OM creation unit 110 sets a probability based on the possibility of being an obstacle for each object whose outline is expressed as a set of coordinate values in the target region 30. Then, the OM creation unit creates the occupancy map 400 that integrates these obstacle presence probabilities in the target region 30 into data such as a floor map (S127), and outputs the data to various units, and the processing ends. The value “0.5” is only one example of the probability of an obstacle moving, and other values such as “0.4” or “0.6” may be used according to the embodiment, as long as the value is greater than “0.2” and less than “0.8” (likewise hereinafter).

As described above, in the second example of the processing of creating the occupancy map 400, the OM creation unit 110 sets the probability of whether the region is a movable region for the mobile object 200 for each object in the target region 30 on the basis of the environmental information 300. The OM creation unit 110 then creates the occupancy map 400, which probabilistically indicates for each object whether its region is a movable or immovable region. By setting a probability for each object on the basis of the presence or absence of an obstacle and the likelihood that the obstacle is movable, the occupancy map 400 can be created that also takes into account obstacle movability.

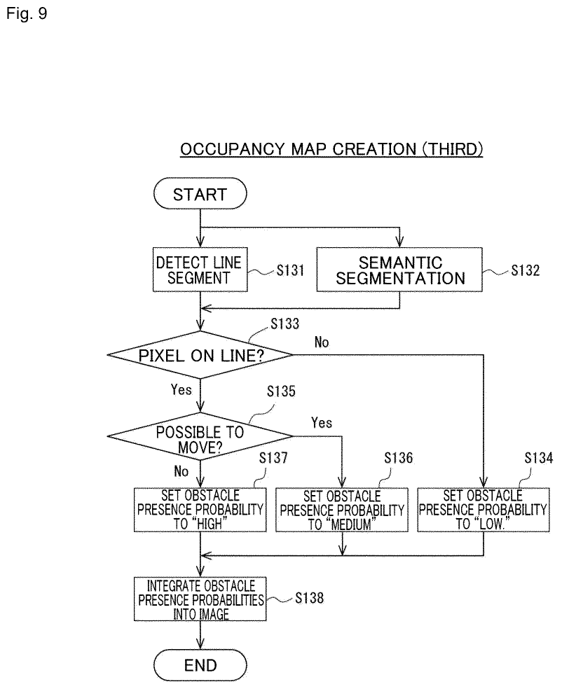

FIG. 9 is a flowchart for illustrating a third example of the occupancy map creation processing. The processing is performed when image data such as a floor map is sent from the user terminal UT to the information processing device 100 as the environmental information 300. This processing and the above-described processing shown in FIGS. 5 and 7 are different in that this processing includes identifying objects and obtaining their meta information by performing image analysis such as semantic segmentation on images that constitute the environmental information 300 to identify the objects.

In this processing, upon the environmental information 300, which is a floor map of the target region 30, the OM creation unit 110 first detects a line segment from the image (S131). Here, the same line segment detection processing (S111) shown in FIG. 5 is performed. The OM creation unit 110 also performs existing recognition processing, such as semantic segmentation, on the floor map, which is the environmental information 300, to identify objects in the target region 30 (S132).

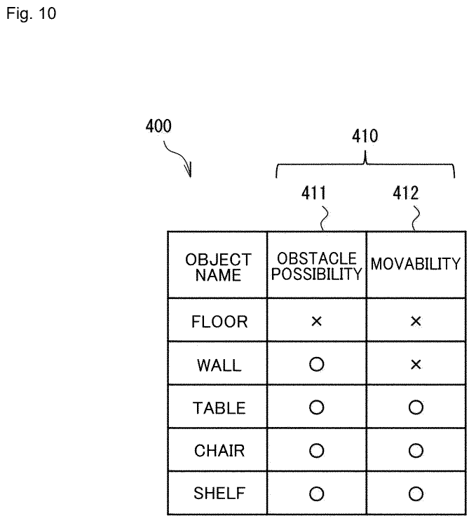

FIG. 10 is a table showing meta information generated from the floor map. The meta information 410 shown in the figure includes the same content as the meta information 320 shown in FIG. 8. In order to generate the meta information, the OM creation unit 110 identifies objects in the floor map for example by semantic segmentation, sets object names, and sets an obstacle possibility and movability on the basis of the object name. In this way, data is generated as the meta information included in the environmental information 300, in which the types of objects on the floor and the obstacle possibility 411 and movability 412 are set for each type of objects.

The OM creation unit 110 then determines, for all pixels 310 in the environmental information 300, whether the pixels 310 that constitute the image of the environmental information 300 are included in a line (S133). Here, the same processing as in step S112 in FIG. 5 is performed. As a result of the determination, if the pixels 310 are not included in a line, the OM creation unit 110 sets the obstacle presence probability to “low” with a value of “0.2” (S134). Meanwhile, if the pixels 310 are included in the line, the OM creation unit 110 determines whether the object related to the pixel is movable (S135). As for an object with a movability, such as the “table” shown in FIG. 10, the OM creation unit 110 sets the obstacle presence probability to be “medium” with a value of “0.5” (S136). Meanwhile, as for an object with no movability, such as the “wall” shown in FIG. 10, the obstacle presence probability is set to “high” with a value of “0.8” (S127).

Through the above-described processing, the OM creation unit 110 sets a probability for each of the pixels 310 on the basis of obstacle possibility and movability, and creates the occupancy map 400 by integrating these obstacle presence probabilities in the target region 30 with the image data (S138). The OM creation unit 110 then outputs the occupancy map 400 to the various parts, and the processing ends.

As described above, in the third example of the processing of creating the occupancy map 400, the OM creation unit 110 sets, for each pixel 310 (unit region) obtained by dividing the target region 30 into multiple parts on the basis of the environmental information 300, the probability of whether the mobile object 200 can move within the region is set. The OM creation unit 110 creates the occupancy map 400 that probabilistically indicates, for each pixel 310, whether the region is a movable or immovable region. The above-described processing allows the creation of the occupancy map 400 that accounts for not only the presence of obstacles but also their movability.

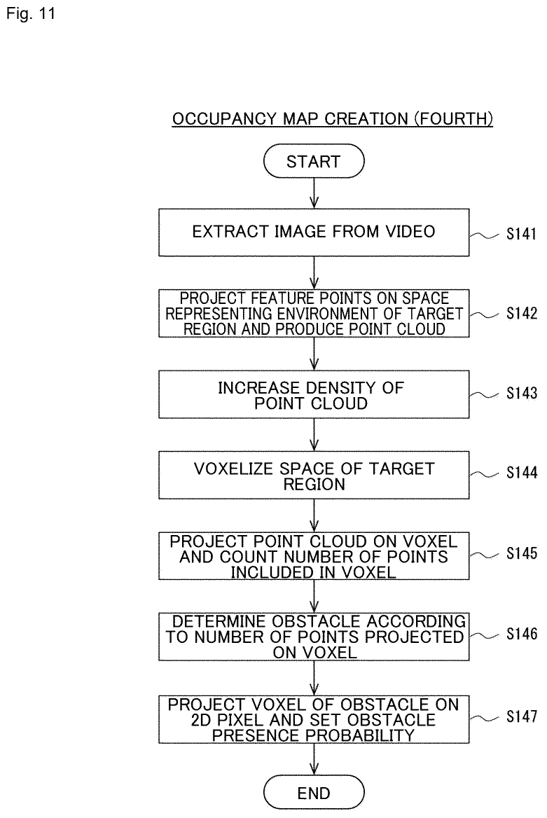

FIG. 11 is a flowchart for illustrating a fourth example of occupancy map creation processing. This processing is performed when a video of the target region 30 is sent from the user terminal UT to the information processing device 100 as the environmental information 300. In this case, the video as the environmental information 300 is captured while varying the viewpoint to include points where walls intersect at right angles within the target region 30.

In this processing, the OM creation unit 110 extracts images from the video as the environmental information 300 (S141). For example, the OM creation unit 110 extracts images from the video at regular frame intervals. In this way, a plurality of images of the target region 30 are generated from multiple viewpoints.

Then, on the basis of the generated multiple images, the OM creation unit 110 creates a point cloud by projecting the feature points corresponding to each other between the multiple images onto the space representing the environment of the target region 30 (S142). Here, the existing SfM (Structure from Motion) processing is used. Through the SfM (Structure from Motion) processing, images of the target region 30 captured from multiple viewpoints are input, resulting in the output of the camera's pose and a sparse point cloud. In this way, a 3D structure (3D model) representing the environment of the target region 30 is output.

Next, the OM creation unit 110 performs the processing of increasing the density of the sparse point cloud output by SfM (S143). On the basis of the camera pose and the sparse point cloud generated by SfM, the OM creation unit 110 uses an existing technique such as MVS (Multiple View Stereo) to increase the density of the point cloud and to reconstruct a dense 3D structure representing the environment of the target region 30.

The OM creation unit 110 divides the space of the target region 30 into voxels on the basis of the size of the unit space (S144). For example, the OM creation unit 110 divides the space of the environmental information 300 into voxels by dividing the space into cubes of an arbitrary size, such as one meter in length, width, and height. The length of the sides of the cubes is set according to the size of the environment and the desired accuracy for the map.

Next, the OM creation unit 110 projects a dense point cloud onto the voxels and counts the number of points included in each voxel in the target region 30 (S145).

The OM creation unit 110 then determines that an obstacle is present when the number of points projected onto the voxel exceeds a prescribed threshold (S146).

Next, the OM creation unit 110 projects voxels having an obstacle onto the unit region of the 2D plane and sets the obstacle presence probability (S147). The obstacle presence probability is set for each pixel obtained by dividing the target region 30 into multiple parts on the basis of the environmental information 300. It is sufficient to project at least the voxels with obstacles onto a 2D plane (XY plane), but voxels without obstacles may be projected onto the 2D plane.

More specifically, the OM creation unit 110 sets the obstacle presence probability to “0.8” for the pixel corresponding to the unit region on which the voxel determined to be an obstacle is projected, and sets the obstacle presence probability to “0.2” for the other pixels. Thus, on the basis of the number of points in the voxel, the OM creation unit 110 sets the obstacle presence probability (the probability of whether the region is movable) for each of the pixels 310 corresponding to the unit region on which the voxel is projected, for the mobile object 200. After setting the obstacle presence probability for all the pixels in the target region 30, the OM creation unit 110 creates the occupancy map 400, which integrates the obstacle presence probabilities in the target region 30 into the image and outputs the map to the various parts, and the processing ends.

As described above, in the fourth example of the processing of creating the occupancy map 400, the OM creation unit 110 reconstructs a 3D structure in the target region 30 as a point cloud on the basis of the video taken of the target region 30 as the environmental information 300. According to the number of points included in the plurality of voxels obtained by dividing the target region 30, the obstacle possibility can be determined for each unit region where the voxel is projected onto a 2D plane, and the occupancy map 400 can be created with a probability set for the pixel corresponding to the unit region. Thus, even when the environmental information 300 such as a floor map is not available, the occupancy map 400 can be created from the video taken of the target region 30.

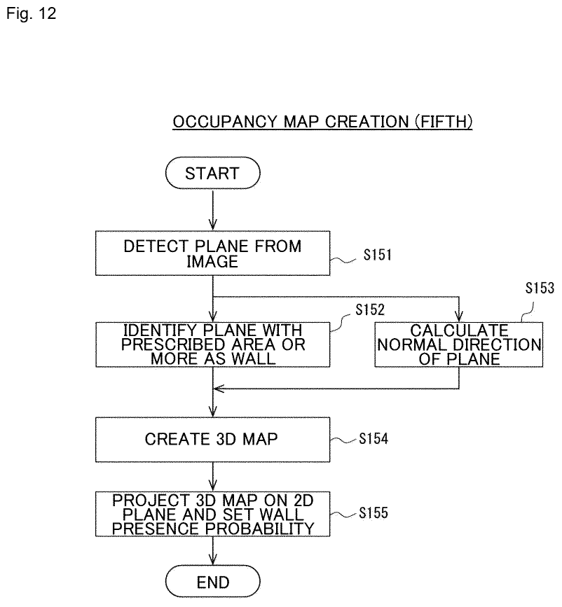

FIG. 12 is a flowchart for illustrating a fifth example of occupancy map creation processing. This processing is performed when multiple images of the target region 30 are sent from the user terminal UT to the information processing device 100 as the environmental information 300. In this case, the multiple images taken as the environmental information 300 are those taken while changing the viewpoint so as to include locations where the walls in the target region 30 intersect at right angles. Information about the floor in the environment shown in these images may be transmitted as the environmental information 300.

In this processing, the OM creation unit 110 first detects a plane using an existing method according to the images taken of the environment of the target region 30 (S 151). Here, the OM creation unit 110 detects whether each pixel is on the same plane by inputting the images of the environmental information 300 into a DNN (Deep Neural Network) model.

The OM creation unit 110 then identifies a plane that exceeds a certain threshold as a wall on the basis of the area of the plane detected by plane detection (S152). The OM creation unit 110 also calculates the normal direction of the detected plane (S153).

Next, the OM creation unit 110 creates a 3D map by processing a group of planes identified as walls on the assumption that adjacent walls are orthogonal to each other (S154). In this processing, planes that are adjacent in the image and have normals in the same direction are merged as one wall. In contrast, two planes that are adjacent in the image and have normals at right angles are determined to be walls that intersect at a corner. The OM creation unit 110 may also identify a plane orthogonal to a floor as a wall by identifying not only the wall but also the floor.

Finally, the OM creation unit 110 projects the 3D map onto a 2D plane (XY plane) and sets the probability of whether the mobile object 200 is in a movable region (obstacle presence probability) as a wall presence probability (S155). Here, the OM creation unit 110 sets the probability of whether the pixel 310 is a movable region on the basis of whether a wall is present or not. More specifically, the OM creation unit 110 projects the 3D map including the plane of the wall onto the 2D plane, and the obstacle presence probability is set to “0.8” for pixels with a wall projected on them, and “0.2” for the other pixels. After setting the obstacle (wall) presence probability for all the pixels in the target region 30, the OM creation unit 110 ends the creation of the occupancy map 400, the map is output to the various parts, and the processing ends.

As described above, in the fifth example of the processing of creating the occupancy map 400, the OM creation unit 110 creates a 3D map of the walls surrounding the target region 30 on the basis of a plurality of images of the target region 30 as the environmental information 300. The walls in the 3D map are projected onto a 2D plane to create the occupancy map 400. According to the processing, the occupancy map 400 can be created from multiple images of the target region 30 even when the environmental information 300 such as a floor map is not available.

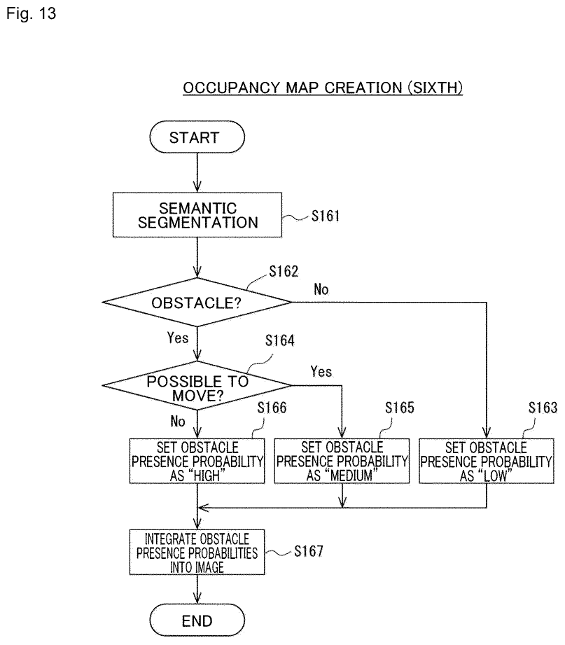

FIG. 13 is a flowchart for illustrating a sixth example of the occupancy map creation processing. This processing is performed when an image of the environment of the target region 30 is sent from the user terminal UT to the information processing device 100 as the environmental information 300. In this case, the image, which is the environmental information 300, is a satellite photograph obtained from a consumer map application.

In this processing, the OM creation unit 110 first performs processing to identify objects by image analysis such as semantic segmentation on the image of the satellite photo, which is the environmental information 300 (S161). As a result, the position and outline of the objects and the meta information of the objects are obtained, and the target region 30 is divided into multiple object regions on the basis of the environmental information 300.

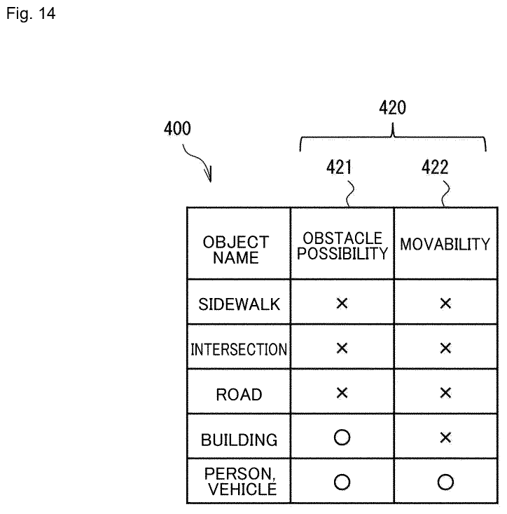

FIG. 14 is a table showing meta information generated from satellite photos. The meta information 410 shown in this figure is similar to the meta information 410 shown in FIG. 10. For example, the OM creating unit 110 identifies what kind of object each of the objects in the satellite photo is, sets the object name, and sets obstacle possibility and movability on the basis of the name of the object. This allows data to be generated in which the types of objects present in the target region 30 and the obstacle possibility and movability for each type of objects are set as meta information included in this environmental information 300. As shown in FIG. 14, the generated meta information 410 is output with an obstacle possibility 411 and a movability 412 set for each object name such as “sidewalk,” “intersection,” “road,” “building,” and “person, car.” More specifically, the meta information 410 includes the obstacle possibility 411 indicating the possibility of the object being an obstacle in the region where it is located (i.e., the region where the mobile object 200 cannot move) and the movability 412 indicating the possibility of the object's position changing. In this way, the probability of whether the region is a movable region (obstacle presence probability) for each object is set on the basis of the presence or absence of an obstacle and the possibility that the obstacle can move.

The OM creation unit 110 then determines whether each object in the target region 30 is an obstacle (S162). In this case, the OM creation unit 110 sets the obstacle presence probability to “low” with a value of “0.2” for objects that have no obstacle possibility, such as the “sidewalk,” “intersection,” and “road” shown in FIG. 14 (S163).

Meanwhile, for objects with obstacle possibility, such as “building” and “person and car” shown in FIG. 14, the OM determines whether there is movability (S164). In this case, the OM creation unit 110 sets the obstacle presence probability to “medium” with a value of “0.5” for objects with movability, such as the “person and car” shown in the figure (S165). Meanwhile, for objects that have no movability, such as the “building” shown in FIG. 14, the OM creation unit 110 sets the obstacle presence probability to “high” with a value of “0.8” (S166).

The OM creation unit 110 creates the occupancy map 400 after setting the obstacle presence probability for all the objects in the target region 30 as described above.

Through the above-described processing, the OM creation unit 110 sets a probability based on the possibility of being an obstacle for each object whose outline is represented as coordinate values in the target region 30. The obstacle presence probabilities in the target region 30 are integrated into the image data to create the occupancy map 400 (S167). The occupancy map 400 is output to the various parts, and the processing ends. In this way, the probability is set by determining the possibility of each object being an obstacle (the possibility that the mobile object 200 cannot move in the region) and the possibility of the object's position varying, and the occupancy map 400 is created.

As described above, in the sixth example of the processing of creating the occupancy map 400, the OM creation unit 110 sets a probability (obstacle possibility) of whether the object is a region in which the mobile object 200 is movable for each object obtained by dividing the target region 30 into multiple parts on the basis of the environmental information 300. The OM creation unit 110 creates the occupancy map 400 that probabilistically indicates for each object whether the object corresponds to a movable region. According to the processing, the occupancy map 400 that can be used to determine the presence or absence of an obstacle from the environmental information 300, which is a satellite photo. In addition, even outdoors, by setting a probability for each object on the basis of the presence or absence of an obstacle and the movability of the obstacle, the occupancy map 400 that also takes into account the obstacle movability can be created.

### <3. Setting of Waypoints and Generation of Action Plans>

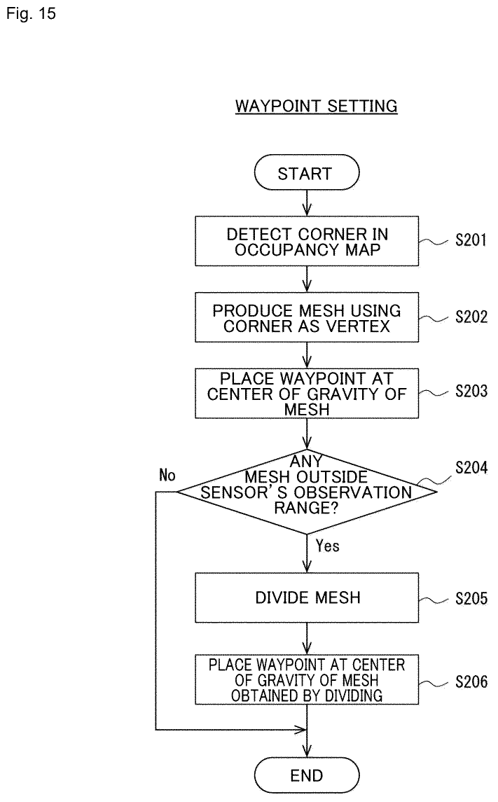

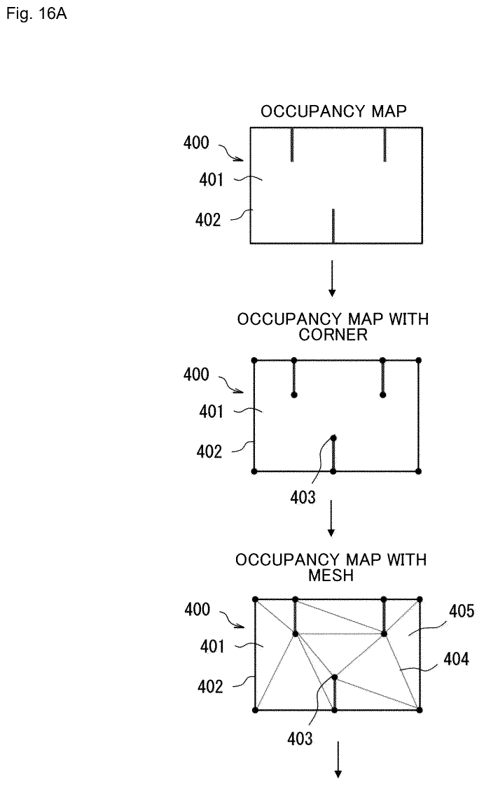

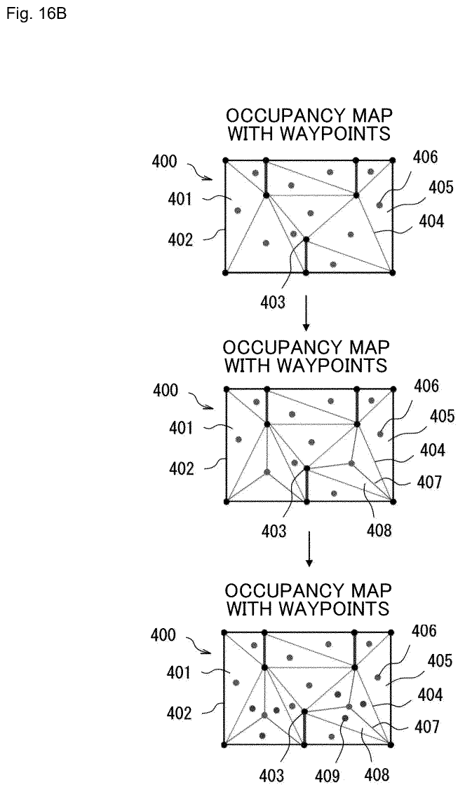

Next, the waypoint setting processing will be described. FIG. 15 is a flowchart for illustrating the waypoint setting processing. FIGS. 16A and 16B illustrate waypoint setting processing.

In this processing, the WP setting unit 120 first detects corners in the occupancy map 400 of the target region 30 (S201), as shown in FIG. 15. In this case, the WP setting unit 120 treats the occupancy map 400 as an image and detects the corner 403 of an obstacle using an existing method such as the Harris corner detection method (see FIG. 16A). The obstacle targeted for corner detection may be an obstacle in a region with a probability equal to or greater than a threshold (e.g., a region with a probability of “0.8”). For example, the corner 403 is set at the intersection of the line segments 402 indicating walls or the endpoints of the line segments 402 indicating a wall in the occupancy map 400. By setting the threshold to a value smaller than 0.5 and larger than 0.2, the region where the probability is set to “0.5” may also be subject to corner detection. For example, a corner of a table that can be moved may also be subject to corner detection.

Next, the WP setting unit 120 generates a mesh 405 using the corner 403 as its vertex (S202). Here, the WP setting unit 120 uses the corner 403 detected in step S201 to generate the mesh 405 surrounded by multiple sides 404 using an existing method such as the Delaunay triangulation. In this way, the polygonal mesh 405 using the corner 403 as the vertex (see FIG. 16A), and the movable region 401 corresponding to the floor (which corresponds to the region with a probability of 0.2 in the occupancy map 400) is covered and divided by the mesh 405. The mesh 405 may be a triangular mesh, as shown in FIG. 16A, or a square mesh or a polygonal mesh with more sides.

The WP setting unit 120 then places waypoints 406 at the center of gravity of the mesh 405 (S203). Here, the WP setting unit 120 calculates the position of the center of gravity of each mesh 405 and places a waypoint 406 at the position. In this way, the waypoint 406 is set at the center of gravity of the mesh 405, enabling control such that the mobile object 200 moves through the center of gravity of the mesh 405 laid out on the floor corresponding to the movable region. In this way, the entire target region 30 is thoroughly covered by the movement of the mobile object 200, so that the environment can be observed. When the region with a probability set to “0.5” is also subject to corner detection, and during sensor measurement by the mobile object, an obstacle with a probability of “0.5” actually exists, occlusion, etc., can be suppressed.

Next, the WP setting unit 120 determines whether there is the mesh 405 outside the observation range of the sensor 210 of the mobile object 200 (S204). In other words, it is determined whether there is a region within the mesh 405 that is not included in the observation range of the sensor 210 when the mobile object 200 is allowed to perform observation at the center of gravity of the mesh 405.

When creating the intermediate map 600, the mobile object 200 observes the environment of the target region 30 using the sensor 210 at waypoints 406, but the measurable range of the sensor 210 is limited to a certain distance from the sensor 210. For this reason, for example, the waypoint 406 must be set so that the distance from the waypoint 406 to the wall 402 along the mesh 405 that includes that waypoint 406 does not exceed the measurement distance of the sensor 210. In this way, on the basis of the observation range of the sensor 210, a plurality of waypoints are set in the occupancy map 400.

If it is determined in step S204 that there is the mesh 405 that exceeds the observation range of the sensor 210 of the mobile object 200, then the WP setting unit 120 divides the mesh 405 into multiple meshes 408 (sub meshes) (S205). Here, the WP setting unit 120 creates the meshes 408 (sub-meshes) by dividing the mesh by the side 407 with the corners 403 detected in step S201 and the waypoint 406 placed in step S203 as the vertices.

Next, the WP setting unit 120 places waypoint at the center of gravity of the mesh 408 (S206). Here, the WP setting unit 120 calculates the center of gravity of the mesh 408 similarly to step S203, and places the waypoint 409 at the location. As a result, the WP setting unit 120 sets waypoints 406 and 409 in the occupancy map 400 representing the target region 30, outputs the map to the action plan generation unit 130, and the waypoint setting processing ends.

Meanwhile, when it is determined in step S204 that there is no mesh 405 that is outside the observation range of the sensor 210 of the mobile object 200, the WP setting unit 120 also sets the waypoint 406 in the occupancy map 400 representing the target region 30. The occupancy map 400A with the waypoint 406 set is output to the action plan generation unit 130, and the processing ends. As described above, by setting the waypoints 406 and 409 in the occupancy map 400, the waypoints 406 and 409 can be set with simple processing so that the environment can be observed in the entire area of the target region 30.

In the above description, the processing of dividing the mesh 405 that is outside the observation range of the sensor 210 is divided only once. When there still remains a mesh 408 that is outside the observation range of the sensor 210 after dividing the mesh 405 one time, the processing of dividing the mesh 408 (S205) and placing the waypoint 409 (S206) may be repeated until there is no more mesh 408 that is outside the observation range of the sensor 210. Using an occupancy map with obstacle presence probabilities set allows efficient setting of waypoints for the mobile object 200 to pass through, which also allows for efficient exploration by the mobile object 200.

Once the waypoints 406 and 409 are set, in the map creation processing shown in FIG. 4, the preliminary map creation unit 140 generates an action plan (first action plan) for the mobile object 200 based on the occupancy map 400A with the waypoints 406 and 409 set (see step S3 in FIG. 4). The preliminary map creation unit 140 outputs the action plan for the mobile object 200 to the preliminary map creation unit 140. In the action plan for the mobile object 200, the mobile object 200 moves through multiple waypoints 406 and 409 and makes observations with the sensor 210 at the multiple waypoints 406 and 409.

In this action plan, a moving path that connects and sequences the multiple waypoints 406 and 409, the posture during movement (traveling), and the details of the operation of observing the environment to be performed at the waypoints are planned. For example, as the moving path, the mobile object 200 is planned to pass through the waypoints 406 and 409 in a sequence that connects the adjacent waypoints 406 and 409. The sequence of connecting the waypoints 406 and 409 is set so that the mobile object can travel through these waypoints 406 and 409 in the shortest amount of time (shortest distance). The observation operation at waypoints 406 and 409 is planned to allow the mobile object 200 to make one rotation while stopping at the waypoints 406 and 409 and to perform ranging in the surrounding environment. The observation operation is not limited to distance measurement but may also include taking pictures using an RGB camera.

### <4. Creation of Preliminary Map and Intermediate Map>

The preliminary map creation unit 140 then creates the preliminary map 500 by attaching an action plan assigned to the occupancy map 400A (see step S4 in FIG. 4) and outputs the map to the map information storage unit 150. In this preliminary map 500, waypoints 503 are set at the same locations as waypoints 406 and 409 in the occupancy map 400A, and the waypoints 503 are connected by the moving path 504.

The information processing device 100 then moves the mobile object 200 on the basis of the preliminary map 500 including the action plan and causes the intermediate map 600 to be created (S5). Here, the preliminary map 500 stored in the map information storage unit 150 is transmitted to the communication unit 270 of the mobile object 200 via the communication unit 160 and over the network NW. The control unit 240 stores the received preliminary map 500 in the map storage unit 260 and also starts creating the intermediate map 600.

In the processing of creating the intermediate map 600, the mobile object 200 controls the drive unit 250 and moves through each waypoint 503 according to the output from the self-position estimation unit 220. Then, the control unit 240 controls the sensor 210 and the drive unit 250 according to the details of the observation operation set at each waypoint 503 to observe the environment of the target region 30.

In the processing of creating the intermediate map 600, the creation of the intermediate map 600 proceeds as the mobile object 200 passes through the waypoint 503 in the preliminary map. For example, the intermediate map creation unit 230 sets the region in the preliminary map 500 determined not to be an obstacle (a pixel with an obstacle presence probability of “0.2”) is set as a “quasi-free space” to be observed for the presence of an obstacle. This is because even if a space is free space (floor) in the preliminary map 500, there is still a possibility that obstacles may exist due to changes in the environment. The region of obstacles that may move with an obstacle presence probability of “0.5” is also observed to see if an obstacle actually exists in that region. Although it is hardly likely that the region of an obstacle with an obstacle presence probability of 0.8 does not have an obstacle, the region may no longer have an obstacle as for example a service entrance has been opened in the wall due to construction, which may not be reflected on the floor map, and therefore the region is subjected to observation. In this way, the intermediate map creation unit 230 performs observation while moving through waypoints on the basis of the preliminary map, and identifies the observed locations as a “free space” or “obstacle”. Then, the intermediate map creation unit 230 sets an obstacle possibility of “0” to the location (region) identified as a “free space” and sets an obstacle possibility of “1” to the location (region) identified as an “obstacle.” In other words, for each location (pixel) for which a probability is set within the range from 0 to 1 in the preliminary map, in the intermediate map, a probability of 0 or 1 is set for each location observed by the mobile object 200. However, due to a sensor detection failure or noise, there is also a possibility that a probability of zero could actually be set to the location of an obstacle.

In the processing of creating the intermediate map 600, most parts of the intermediate map 600 are usually observed (created) as the mobile object 200 passes through all waypoints 503 placed in the preliminary map. However, the environment of the target region 30 may change since the creation of the occupancy map, for example, obstacles in the target region 30 that may be movable (obstacles with a probability of “0.5”) may have moved or new obstacles may have been placed at the time of observation by the mobile object 200. In this case, occlusion, for example, may occur and observation may not be made for some regions, and the intermediate map 600 may not be completed for the entire area. Thus, even if observation is made at all the waypoints 503, the intermediate map 600 may not be made for some regions.

Therefore, the control unit 240 stores the intermediate map 600 created up to the point in the map storage unit 260 and transmits the to the information processing device 100. In the information processing device 100, the intermediate map 600 received from the mobile object 200 is input to the occlusion processing unit 170 via the communication unit 160 and is also stored in the map information storage unit 150.

The occlusion processing unit 170 then determines whether there is any unobserved region such as occlusion, in the intermediate map 600 (S6). Here, the occlusion processing unit 170 reads out the preliminary map 500 from the map information storage unit 150 and compares the preliminary map 500 with the intermediate map 600 to determine whether the intermediate map 600 has been created for the entire target region 30 (all pixels) in the preliminary map 500.

For example, the occlusion processing unit 170 determines whether an intermediate map 600 has been created for all pixels in the preliminary map 500. If the intermediate map 600 has been created for all pixels of the preliminary map 500, the final map creation unit 180 is instructed to create the final map 700, assuming that there are no unobserved regions. The final map creation unit 180 then creates the final map 700 (see below for details).

In contrast, when there is a pixel for which the intermediate map 600 has not been created among all the pixels in the preliminary map 500, the occlusion processing unit 170 determines that there is an unobserved region. The occlusion processing unit 170 causes the WP setting unit 120 to set waypoints so that the intermediate map 600 can be created and updated for the unobserved region in the preliminary map 500.

Upon receiving the output of the waypoints from the WP setting unit 120, the action plan generation unit 130 generates an action plan (second action plan) to observe the environment for the unobserved region in the target region 30. The action plan generation unit 130 transmits an action plan for updating the intermediate map 600 to the mobile object 200 via the communication unit 160 and the network NW.

The mobile object 200 performs the operation of creating the intermediate map 600 similarly to step S5, and the intermediate map creation unit 230 updates the intermediate map 600 by creating the intermediate map 600 for the region that remains unobserved due to occlusion (S7). The control unit 240 of the mobile object 200 observes the unobserved region of the intermediate map 600 according to the action plan for the unobserved region on the map that remains unobserved in the processing of creating the intermediate map 600 in step S5 in FIG. 4. Upon completion of the observation of the unobserved region, the intermediate map 600 is updated.

As described above, the mobile object 200 is used to create the intermediate map 600 using the preliminary map 500, so that the mobile object 200 can observe the environment while passing through the waypoints 503 set in the preliminary map 500. This allows for efficient map creation by eliminating unnecessary actions during the exploration.

The occlusion processing unit 170 identifies the region for which the intermediate map 600 has not been created due to an unobserved region caused for example by occlusion, and has the WP setting unit 120 re-set waypoints in order to have the mobile object 200 observe the detected unobserved region. The mobile object 200 is moved again according to the re-set waypoints to observe the unobserved region. In this way, even if the environment changes after the occupancy map is created, the map can still be created efficiently.

In creating the intermediate map 600 in the intermediate map creation unit 230, a method for determining the location of obstacles in the target region 30 by the ranging data (especially distance information) generated by the sensor 210 can be used. As an example, a method is used to determine that an obstacle exists at the position indicated by the distance shown by the ranging data.

After completing the creation of the intermediate map 600, various kinds of comparative evaluation may be performed using the intermediate map 600, the preliminary map 500, and the floor map, which is the environmental information 300. For example, the information processing device 100 is provided with a comparison and evaluation unit (not shown) that executes comparison and evaluation processing. The comparison and evaluation unit may compare the intermediate map 600 with the preliminary map 500 or the intermediate map 600 with the floor map, which is the environmental information 300, to create data, in which the changes are visualized, and transmit the data to the user terminal UT. The comparison and evaluation unit may also evaluate the quality of the intermediate map 600 (e.g., the presence of noise) by comparing the intermediate map 600 with the preliminary map 500. The comparison and evaluation unit may also simulate the creation of the intermediate map 600 by creating a 3D model from the floor map as the environmental information 300 and using the action plan generated in the preliminary map 500.

When the intermediate map 600 is created using the sensor 210 of the monocular camera, it may be difficult to obtain distance information, and the size of the intermediate map 600 may not be set correctly. Therefore, the size of the intermediate map 600 can be corrected by the comparison and evaluation unit by matching the size of the intermediate map 600 to the preliminary map 500 that correctly reflects the size of the environment of the target region 30.

### <5. Final Map Creation>

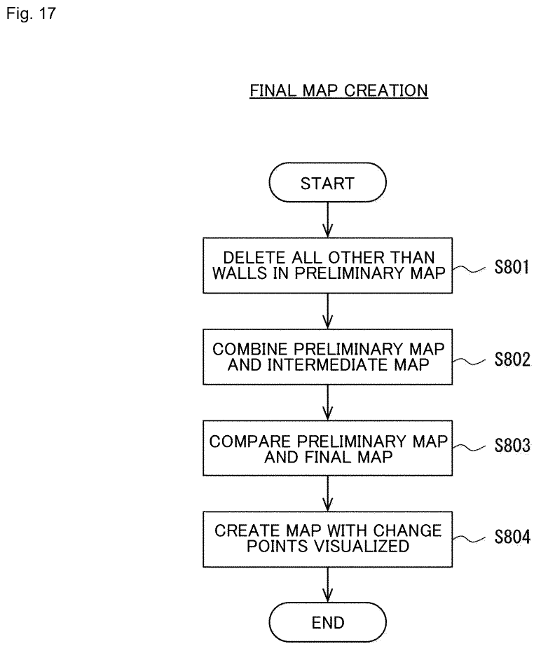

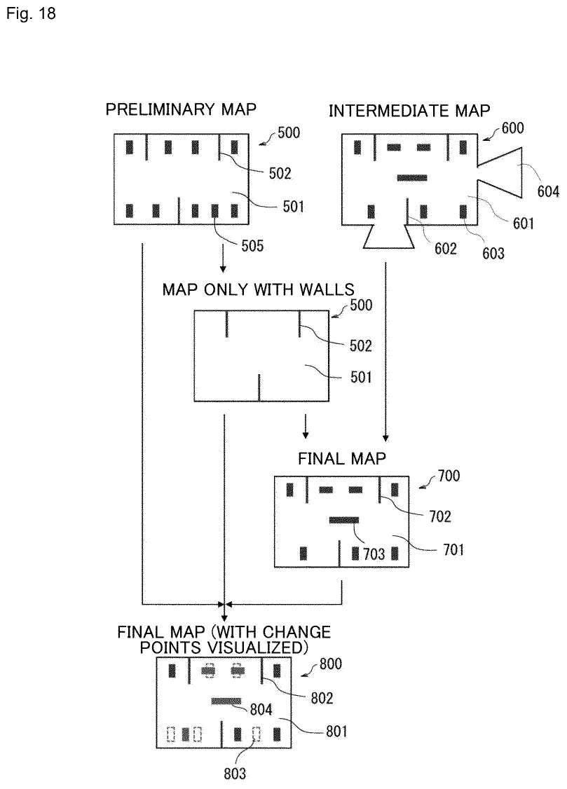

A final map 700 is created as the last processing in the map creation processing according to the embodiment. FIG. 17 is a flowchart for illustrating the final map creation processing. FIG. 18 illustrates the final map creation processing.

In the processing, the final map creation unit 180 first deletes all but the walls 502 of the preliminary map 500 (S801). For example, the final map creation unit 180 deletes an object such as a table 505 as an object located on the floor 501 in the target region 30 from the preliminary map 500. Objects other than walls can be determined by using, for example, the meta information 320 shown in FIG. 8.

The final map creation unit 180 then combines the preliminary map 500 and the intermediate map 600 (S802). Here, the final map creation unit 180 creates the final map 700 by combining the preliminary map 500, from which objects other than walls are deleted, and the intermediate map 600, which is created by the mobile object 200 which has actually observed the environment. In other words, the final map creation unit 180 reflects in the intermediate map 600 the information on the walls 502, having an obstacle presence probability of “0.8” set as “high” from the preliminary map 500. This removes noise 604 where walls are not correctly recognized in the intermediate map 600, as shown in FIG. 18. For example, when there is a white wall 602 in the target region 30, it is difficult to observe, and the noise 604 can be generated because of incorrect identification of the wall shape as not being an obstacle. In other words, the region that is determined as “a free space” by the noise 604 and set to a probability of “0” in the intermediate map 600 is also set to “high” in the preliminary map 500, i.e., the obstacle presence probability is set to “0.8”. This results in a discrepancy (inconsistency) between the two. For the region where such a discrepancy occurs, the final map 700 gives priority to the determination result indicated by the preliminary map (information indicating that the region is highly likely to be an obstacle) and sets the obstacle presence probability to “1”. In other words, a higher weight (priority) than the intermediate map is set for a location with a high presence probability.

Through the above-described processing, the final map creation unit 180 creates the final map 700 by setting an obstacle presence probability of “0” or “1” for each region (for each pixel). The final map 700 definitively represents the movable and immovable regions in the target region 30. In this final map 700, it can be seen that the floor 701 is separated by walls 702, and a table 703 is placed at a prescribed position on the floor 701. At this stage, the final map creation unit 180 may store the final map 700 in the map information storage unit 150, transmit the map 700 to the user terminal UT, and end the processing of creating the final map 700. This final map 700 may combine good parts of the highly accurate preliminary map 500 and the intermediate map 600 based on the observation of the latest environment to create the final map 700.

In the final map creation processing in FIG. 17, the final map creation unit 180 further compares the preliminary map 500 with the final map 700 (S803) in order to make better use of the created final map 700.

The final map creation unit 180 then creates a map that visualizes the changes (difference) (S804). Here, information indicating the difference between the preliminary map 500 and the intermediate map 600 is placed in the final map (change point visualization map) 800. More specifically, information indicating the difference between the movable (floor 501) region and immovable (wall 502 and table 505) region in the preliminary map 500 and the movable (floor 601) and immovable regions (walls 602 and table 603) in the intermediate map 600 is placed in the final map 800. Specifically, in this map 800, the line type of the outline or the color of the region is changed for the table 803 corresponding to the table 505 in the preliminary map 500 and the table 804 corresponding to the table 703 in the final map 700, and so on. In this way, the parts that differ between the preliminary map 500 and the intermediate map 600 are displayed in a distinguishable manner. For example, the table 804 corresponds to the table 703 that does not exist in the preliminary map 500 but exists in the intermediate map 600. The table 803 corresponds to the table which is present in the preliminary map 500 but does not exist in the intermediate map 600. This allows for confirmation of changes in the environment, such as changes in seating positions in the workplace.

Using the final maps 700 and 800 created by the above described method, the mobile object 200 or other autonomously movable object (vehicle or robot) can autonomously travel (autonomously move) within the target region 30 and perform tasks (e.g., capturing images) according to the purpose.

### <6. Summary>

As described above, the information processing device 100 according to the present disclosure creates the occupancy map 400, which probabilistically indicates movable and immovable regions in the target region 30, on the basis of the environmental information 300 (for example, a floor map) that indicates an environment of the target region 30. Using the preliminary map 500 based on the occupancy map 400, the intermediate map 600 representing the movable and immovable regions in the target region 30 is created by moving the mobile object 200 including the sensor 210 in the target region 30 to observe the environment of the target region 30. The occupancy map 400 (preliminary map 500) and the intermediate map 600 are combined to create the final map 700, which definitively represents the movable and immovable regions in the target region 30. In this way, maps can be created more efficiently than the case of map creation by hand or by robot's exploratory action without any preliminary map information.

### <7. Application Example>

An application example of the map creation system 1000 will be described. It should be noted that the above-described map creation can also be applied to any system, device, or method related to the map creation system 1000 in the following description.

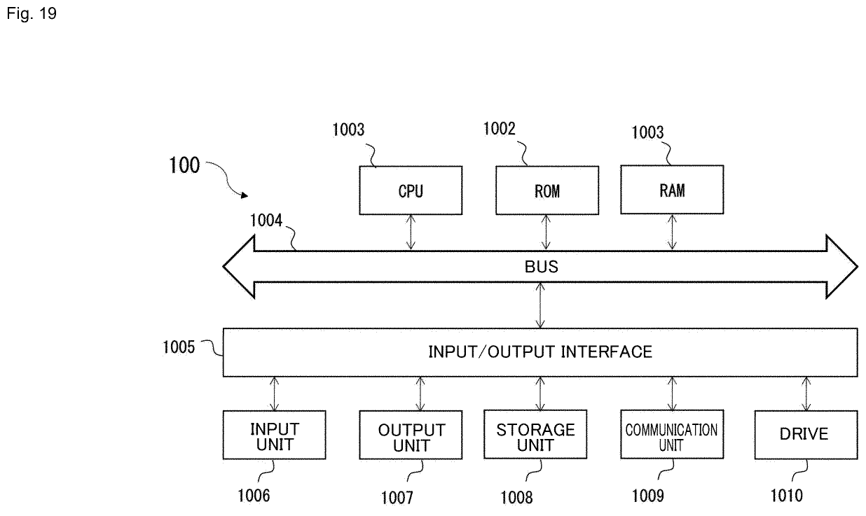

FIG. 19 illustrates an example of the hardware configuration of a computer that executes the series of processing operations of the map creation system 1000 according to the present disclosure by a program. The CPU 1001, ROM 1002, and RAM 1003 are connected to each other via the bus 1004.

An input/output interface 1005 is also connected to the bus 1004. An input unit 1006, an output unit 1007, a storage unit 1008, a communication unit 1009, and a drive 1010 are connected to the input/output interface 1005.

The input unit 1006 includes, for example, a keyboard, a mouse, a microphone, a touch panel, or an input terminal. The output unit 1007 includes, for example, a display, a speaker, or an output terminal. The storage unit 1008 includes, for example, a hard disk, a RAM disk, or a non-volatile memory. The communication unit 1009 includes, for example, a network interface. The drive drives a removable medium such as a magnetic disk, an optical disk, a magneto-optical disk, or a semiconductor memory.

In the computer that has the above configuration, for example, the CPU 1001 performs the above-described series of processing operations by loading a program stored in the storage unit 1008 to the RAM 1003 via the input/output interface 1005 and the bus 1004 and executing the program. The RAM 1003 also appropriately stores data and the like necessary for the CPU 1001 to execute various types of processing.

The program to be executed by the computer, for example, can be recorded on a removable medium such as a package medium and applied. In this case, the program can be installed in the storage unit 1008 via the input/output interface 1005 as the removable medium is mounted in the drive 1010.

This program can also be provided via wired or wireless transfer medium such as a local area network, the Internet, and digital satellite broadcasting. In this case, the program can be received by the communication unit 1009 and installed in the storage unit 1008.

### <8. Supplements>>

According to the above-described embodiment, the probability of whether a region is an immovable region is “1” when an obstacle is present (when the region is immovable) and “0” when an obstacle is not present,” while the probability may be “1” when no obstacle is present and “0” when an obstacle is present. This case can be implemented as appropriate similarly to the above-described embodiment by necessary reinterpretation of the above description.

Each of the processing performed by the information processing device or mobile object disclosed herein may be performed by either of them, except for processing that can only be performed by each of them (e.g., observation of the environment). For example, the information processing device 100 may create the intermediate map 600. The mobile object 200 may also function as the map creation system 1000, comprising the functions of the information processing device 100, create the occupancy map 400, the preliminary map 500, and the final map 700, and perform the entire map creation processing shown in FIG. 4. The mobile object 200 may also perform part of the processing performed by the information processing device 100.

The processing steps disclosed herein do not necessarily need to be executed in the order described in the flowcharts. For example, the steps may be executed in an order different from that described in the flowcharts, or some of the steps described in the flowcharts may be executed in parallel.

It should be noted that the present invention is not limited strictly to the above embodiments, and at the implementation stage, the elements can be modified and embodied without departing from the gist of the invention. Various inventions can be formed by combining multiple elements disclosed in the above embodiments as appropriate.

For example, some elements may be deleted from all the elements shown in the embodiments. Furthermore, elements across different embodiments may be combined as appropriate.

In addition, the effects of the present disclosure described herein are merely exemplary and may have other effects.

The present disclosure may have the following configuration.

### [Item 1]

An information processing method including: creating, on the basis of
environmental information that indicates an environment of a target region, a first map that indicates a movable region and an immovable region in the target region;
on the basis of the first map, moving a mobile object including a sensor in the target region and observing the environment of the target region, thereby creating a second map that indicates a movable region and an immovable region in the target region; and
combining the first map and the second map, thereby creating a third map.

### [Item 2]

The information processing method according to item 1, further including: setting multiple observation points in the movable region in the first map on the basis of a range of observation by the sensor;
producing a first action plan to have the mobile object move through the multiple observation points and have the sensor make observation at the multiple observation points; and
having the mobile object operate on the basis of the first action plan, thereby creating the second map.

### [Item 3]

The information processing method according to item 2, wherein the first map indicates a probability of whether each unit region is the movable region, the unit region being obtained by dividing the target region into multiple regions on the basis of the environmental information,
the movable region in the first map is a region having a probability of being the immovable region, the probability being a probability of a first threshold or less, and the immovable region in the first map is a region having a probability of being the immovable region, the probability being a probability of a second threshold or greater.

### [Item 4]

The information processing method according to item 3, further including performing corner detection on the basis of a region having a probability of being the movable region, the probability being a probability of a threshold or greater; producing a polygonal mesh using the corner detected by the corner detection as a vertex; and setting the observation point at the center of gravity of the mesh.

### [Item 5]

The information processing method according to item 4, wherein when the mobile object is caused to make observation at the center of gravity and when a region not included in the range of observation by the sensor exists in the mesh including the center of the gravity, the mesh is divided into multiple sub meshes, and the observation point is set at the center of gravity of the sub mesh.

### [Item 6]

The information processing method according to any one of Items 3 to 5, wherein the immovable region is a region having an obstacle therein, and for each of the unit regions, the probability is set on the basis of the presence or absence of the obstacle and a possibility of the obstacle moving.

### [Item 7]

The information processing method according to any one of items 3 to 6, wherein the environmental information includes a photographed image of an environment of the target region,
the unit region corresponds to a pixel in the image,
a line segment is detected from the image, and the probability is set for the unit region on the basis of whether the pixel corresponding to the unit region is included in the line segment detected by the line segment detection.

### [Item 8]

The information processing method according to any one of items 3 to 7, wherein the environmental information includes the location of an object existing in the target region and meta information about the object, and
on the basis of the meta information, the probability is set for the unit region included in a region where the object is located.

### [Item 9]

The information processing method according to item 8, wherein the meta information includes information indicating a possibility of the object being an obstacle and information indicating a possibility of the location of the object varying.

### [Item 10]

The information processing method according to item 8 or 9, wherein the environmental information includes a photographed image of an environment of the target region, and
semantic segmentation is performed on the image to obtain the location of the object and the meta information about the object.

### [Item 11]

The information processing method according to any one of items 3 to 10, further including:
on the basis of multiple images of the target region photographed from multiple viewpoints, projecting feature points mutually corresponding between the multiple images onto a space representing the environment of the target region and producing a point cloud;
performing processing to increase density of the point cloud;
projecting the point cloud on multiple voxels obtained by dividing the space according to the size of the unit region, thereby counting the number of points included in the voxel; and
on the basis of the number of points included in the voxel, setting the probability for the unit region corresponding to the voxel.

### [Item 12]

The information processing method according to any one of items 3 to 11, further including:
detecting a plane on the basis of a photographed image of an environment of the target region;
detecting a wall on the basis of an area of the plane detected by the plane detection and a normal direction of the plane; and
setting the probability for the unit region on the basis of whether the wall is present in the unit region.

### [Item 13]

The information processing method according to any one of items 2 to 12, further including:
comparing the first map and the second map to detect a region unobserved by the mobile object;
producing a second action plan to have the mobile object observe an environment of the detected region; and
on the basis of the second action plan, having the mobile object operate to update the second map.

### [Item 14]

The information processing method according to any one of items 3 to 13, the immovable region having a probability that is the second threshold or greater in the first map is set as the immovable region in the third map even in a case where the region is the movable region in the second map.

### [Item 15]

The information processing method according to any one of items 1 to 14, further including detecting a difference between the first map and the second map and placing, in the third map, information indicating the detected difference.

### [Item 16]

The information processing method according to any one of items 1 to 15, wherein the sensor is any of a monocular camera, a stereo camera, a depth sensor, and a LiDAR, or a combination thereof.

### [Item 17]

An information processing device including:
a first map creation unit configured to create a first map that indicates a movable region and an immovable region in a target region on the basis of environmental information about an environment of the target region;
a second map creation unit configured to, on the basis of the first map, move a mobile object including a sensor in the target region and observe the environment of the target region, thereby creating a second map that indicates a movable region and an immovable region in the target region; and
a third map creation unit configured to combine the first map and the second map, thereby creating a third map.

### [Item 18]

An information processing system including a mobile object having a sensor configured to observe an environment of a target region and
an information processing device capable of communicating with the mobile object, the information processing device including a first map creation unit configured to create, on the basis of environmental information indicating the environment of the target region, a first map that indicates a movable region and an immovable region in the target region,
the mobile object or the information processing device including a second map creation unit configured to, on the basis of the first map, move the mobile object in the target region and observe the environment of the target region, thereby creating a second map that indicates a movable region and an immovable region in the target region,
the information processing device including a third map creation unit configured to combine the first map and the second map, thereby creating a third map.

### REFERENCE SIGNS LIST

30 Target region
100 Information processing device
110 Occupancy map creation unit (OM creation unit)
120 Waypoint setting unit (WP setting unit)
130 Action plan generation unit
140 Preliminary map creation unit
150 Map information storage unit
160, 270 Communication unit
170 Occlusion processing unit
180 Final map creation unit
200 Moving object
210 Sensor
220 Self-position estimation unit
230 Intermediate map creation unit
240 Control unit
250 Drive unit
260 Storage unit
300 Environmental information
301 Movable region (floor)
302, 402 Line segment
303 Obstacle (immovable region)
310, 311, 312, 313 pixel
320, 410 Meta information
321, 411 Obstacle possibility
322, 412 Movability
400 Occupancy map
403 Corner
404, 407 Side
405 Mesh
408 Mesh (Sub mesh)
406, 409, 503 Waypoint (observation point)
500 Preliminary map
501, 601, 701, 801 Floor
502, 602, 702, 802 Wall
504 Moving path
505, 603, 703, 803 Desk
600 Intermediate map
604 Noise
700, 800 Final map
1000 Map creation system
1001 CPU
1002 ROM
1003 RAM
1004 Bus
1005 Input/output interface
1006 Input unit
1007 Output unit
1008 Storage unit
1009 Communication unit
1010 Drive
NW Network
US User
UT User terminal

1. An information processing method comprising:
creating, on the basis of environmental information that indicates an environment of a target region, a first map that indicates a movable region and an immovable region in the target region;
on the basis of the first map, moving a mobile object including a sensor in the target region and observing the environment of the target region, thereby creating a second map that indicates a movable region and an immovable region in the target region; and
combining the first map and the second map, thereby creating a third map.

2. The information processing method according to claim 1, further comprising:
setting multiple observation points in the movable region in the first map on the basis of a range of observation by the sensor;
producing a first action plan to have the mobile object move through the multiple observation points and have the sensor make observation at the multiple observation points; and
having the mobile object operate on the basis of the first action plan, thereby creating the second map.

3. The information processing method according to claim 2, wherein
the first map indicates a probability of whether each unit region is the movable region, the unit region being obtained by dividing the target region into multiple regions on the basis of the environmental information,
the movable region in the first map is a region having a probability of being the immovable region, the probability being a probability of a first threshold or less, and the immovable region in the first map is a region having a probability of being the immovable region, the probability being a probability of a second threshold or greater.

4. The information processing method according to claim 3, further comprising performing corner detection on the basis of a region having a probability of being the movable region, the probability being a probability of a threshold or greater; producing a polygonal mesh using the corner detected by the corner detection as a vertex; and setting the observation point at the center of gravity of the mesh.

5. The information processing method according to claim 4, wherein when the mobile object is caused to make observation at the center of gravity and when a region not included in the range of observation by the sensor exists in the mesh including the center of the gravity, the mesh is divided into multiple sub meshes, and the observation point is set at the center of gravity of the sub mesh.

6. The information processing method according to claim 3, wherein
the immovable region is a region having an obstacle therein, and
for each of the unit regions, the probability is set on the basis of the presence or absence of the obstacle and a possibility of the obstacle moving.

7. The information processing method according to claim 3, wherein
the environmental information includes a photographed image of an environment of the target region,
the unit region corresponds to a pixel in the image,
a line segment is detected from the image, and the probability is set for the unit region on the basis of to whether the pixel corresponding to the unit region is included in the line segment detected by the line segment detection.

8. The information processing method according to claim 3, wherein
the environmental information includes the location of an object existing in the target region and meta information about the object, and
on the basis of the meta information, the probability is set for the unit region included in a region where the object is located.

9. The information processing method according to claim 8, wherein the meta information includes information indicating a possibility of the object being an obstacle and information indicating a possibility of the location of the object varying.

10. The information processing method according to claim 8, wherein
the environmental information includes a photographed image of an environment of the target region, and
semantic segmentation is performed on the image to obtain the location of the object and the meta information about the object.

11. The information processing method according to claim 3, further comprising: on the basis of multiple images of the target region photographed from multiple viewpoints, projecting feature points mutually corresponding between the multiple images onto a space representing the environment of the target region and producing a point cloud;
performing processing to increase density of the point cloud;
projecting the point cloud on multiple voxels obtained by dividing the space according to the size of the unit region, thereby counting the number of points included in the voxel; and
on the basis of the number of points included in the voxel, setting the probability for the unit region corresponding to the voxel.

12. The information processing method according to claim 3, further comprising: detecting a plane on the basis of a photographed image of an environment of the target region; detecting a wall on the basis of an area of the plane detected by the plane detection and a normal direction of the plane; and setting the probability for the unit region on the basis of whether the wall is present in the unit region.

13. The information processing method according to claim 2, further comprising: comparing the first map and the second map to detect a region unobserved by the mobile object;
producing a second action plan to have the mobile object observe an environment of the detected region; and
on the basis of the second action plan, having the mobile object operate to update the second map.

14. The information processing method according to claim 3, the immovable region having a probability that is the second threshold or greater in the first map is set as the immovable region in the third map even in a case where the region is the movable region in the second map.

15. The information processing method according to claim 1, further comprising detecting a difference between the first map and the second map and placing, in the third map, information indicating the detected difference.

16. The information processing method according to claim 1, wherein the sensor is any of a monocular camera, a stereo camera, a depth sensor, and a LiDAR, or a combination thereof.

17. An information processing device comprising:
a first map creation unit configured to create a first map that indicates a movable region and an immovable region in a target region on the basis of environmental information about an environment of the target region;
a second map creation unit configured to, on the basis of the first map, move a mobile object including a sensor in the target region and observe the environment of the target region, thereby creating a second map that indicates a movable region and an immovable region in the target region; and
a third map creation unit configured to combine the first map and the second map, thereby creating a third map.

18. An information processing system comprising:
a mobile object having a sensor configured to observe an environment of a target region; and
an information processing device capable of communicating with the mobile object, the information processing device including a first map creation unit configured to create, on the basis of environmental information indicating the environment of the target region, a first map that indicates a movable region and an immovable region in the target region,
the mobile object or the information processing device including a second map creation unit configured to, on the basis of the first map, move the mobile object in the target region and observe the environment of the target region, thereby creating a second map that indicates a movable region and an immovable region in the target region,
the information processing device including a third map creation unit configured to combine the first map and the second map, thereby creating a third map.
